(19) United States
(12) Patent Application Publication
(10) Pub. No.: US 2025/0146352 A1
(43) Pub. Date: May 8, 2025

(54) Device and Method for Closing a Flap of a Vehicle

(71) Applicant: Vitesco Technologies GmbH, Regensburg (DE)

(72) Inventor: Philippe Grass, Regensburg (DE)

(73) Assignee: Vitesco Technologies GmbH, Regensburg (DE)

(21) Appl. No.: 18/684,322

(22) PCT Filed: Aug. 10, 2022
(86) PCT No.: PCT/EP2022/072466

§ 371 Date: Feb. 16, 2024

(30) Foreign Application Priority Data
Aug. 19, 2021 (DE) 10 2021 209 108.3

(51) Int. Cl. E05F 15/73; E05F 15/40

(52) U.S. Cl. CPC E05F 15/73; E05F 15/40; E05Y 2400/446; E05Y 2400/54; E05Y 2900/531

(57) ABSTRACT

Embodiments of the teachings herein include a device for closing a vehicle flap. An example device may include: a device to open and close the flap; a first sensor to detect a target movement of a body part in the vicinity and to provide an activation signal indicating a desired opening or closing movement of the vehicle flap; a second sensor to detect movements of the vehicle and to generate a movement signal indicating movement of the vehicle; and a control unit to receive the activation signal and the movement signal, and to actuate the opening and closing device. The control unit actuates the opening and closing device for the desired closing of the vehicle flap when an activation signal of the first sensor has been received and the movement signal of the second sensor indicates a movement of the vehicle smaller than a predetermined movement threshold value.

### CROSS-REFERENCE TO RELATED APPLICATIONS

This application is a U.S. National Stage Application of International Application No. PCT/EP2022/072466 filed Aug. 10, 2022, which designates the United States of America, and claims priority to DE Application No. 10 2021 209 108.3 filed Aug. 19, 2021, the contents of which are hereby incorporated by reference in their entirety.

### TECHNICAL FIELD

The present disclosure relates to vehicles. Various embodiments of the teachings herein include devices and/or methods for closing a vehicle flap of a vehicle, in particular a vehicle with contactless actuation of an opening and closing device for opening and closing the vehicle flap.

### BACKGROUND

Modern vehicles are often equipped with sensors which allow contactless adjustment of vehicle doors. For example, a vehicle user is enabled to contactlessly actuate (that is to say open or close) a vehicle door. Sensors of this type are for example provided in the case of motor-adjustable liftgates of motor vehicles, wherein the vehicle user can cause an opening or closing of the liftgate by means of a corresponding leg movement without having to put down a load which is held in their hands.

It is known to provide devices on vehicles, by means of which a vehicle flap is opened by touching of the device with the hand or a finger by an access-authorized person. The vehicle flap is essentially a vehicle door or a liftgate or a luggage compartment door. In addition, devices have been established in the past that allow contactless actuation (i.e. opening or closing) of the vehicle flap. In particular, such devices are advantageous in situations in which the access-authorized person does not have a hand free and consequently can open the vehicle flap by means of a predefined movement of a body part, such as the foot and/or leg.

Examples of sensor devices and control methods for this purpose are known from JP 2015/014124 A, US 2005/168010 A, US 2009/092284 A, DE 10 2010 008 888 A1, JP 2015/014125 A, DE 10 2009 012 889 A1, JP 2015/014126 A, DE 10 2016 109 585 A1, US 2016/369551 A, US 2017/268280 A, DE 10 2018 118 387 A1, DE 10 2019 214 584 A1 and DE 10 2021 000 253 A1.

### SUMMARY

The teachings of the present disclosure may be used to increase the security for an access-authorized person of a vehicle and detecting an accidental contactless actuation of an opening and closing device of a vehicle flap of the vehicle and preventing closure of the vehicle flap. For example, some embodiments include a device (100) for closing a vehicle flap of a vehicle, wherein the device (100) has: an opening and closing device (110) designed to open or close the vehicle flap, a first sensor device (120), which is designed to contactlessly detect a target movement of a body part of a person in the immediate vicinity of the vehicle and to provide an activation signal indicating a desired opening or closing movement of the vehicle flap, a second sensor device (130), which is designed to detect movements of the vehicle and to generate a movement signal indicating a detected movement of the vehicle, and a control unit (140), which is designed to receive the activation signal of the first sensor device (120) and the movement signal of the second sensor device (130) and to actuate the opening and closing device (110), wherein the control unit (140) is designed to actuate the opening and closing device (110) for the desired closing of the vehicle flap when an activation signal of the first sensor device (120) has been received and the movement signal of the second sensor device (130) indicates a movement of the vehicle which is smaller than a predetermined movement threshold value.

In some embodiments, the first sensor device (120) and the second sensor device (130) are integrated in a sensor unit (125).

In some embodiments, the first sensor device (120) and the second sensor device (130) are designed to be mounted separately from each other on the vehicle.

In some embodiments, the second sensor device (120) is a vibration sensor, an acceleration sensor, a position sensor for detecting relative position changes of the vehicle with respect to the ground, a distance sensor for detecting distance changes of the vehicle body with respect to the ground or a force sensor for detecting deformations of the vehicle body.

In some embodiments, the movement signal indicates shocks, vibrations and/or accelerations of the vehicle.

In some embodiments, the predetermined movement threshold value is defined in such a way that a vehicle which has just begun to move is indicated.

As another example, some embodiments include a vehicle having a device (100) as described herein, wherein the first sensor device ( ) has a detection range in which the first sensor device ( ) can contactlessly detect the target movement of the body part of the person in the immediate vicinity of the vehicle, and is mounted on the vehicle in such a way that the detection range ( ) of the first sensor device ( ) extends at least partially to the outside of the vehicle.

In some embodiments, the vehicle has a device (100) comprising an opening and closing device (110) which is designed to open or close the vehicle flap, a first sensor device (120) which is designed to contactlessly detect a target movement of a body part of a person in the immediate vicinity of the vehicle, and a second sensor device (130), which is designed to detect movements of the vehicle, wherein the method comprises: detecting a target movement of the body part of the person in the immediate vicinity of the vehicle by means of the first sensor device (120), the target movement indicating a desired closing of the vehicle flap, detecting a movement of the vehicle by means of the second sensor device (130), and actuating the opening and closing device (110) for closing the vehicle flap if the detected movement of the vehicle is smaller than a predetermined movement threshold value.

In some embodiments, the detection of the movement of the vehicle comprises: detecting shaking of the vehicle, and/or detecting vibrations of the vehicle, and/or detecting an acceleration of the vehicle.

In some embodiments, the predetermined movement threshold value is defined in such a way that a vehicle which has just begun to move is indicated.

### BRIEF DESCRIPTION OF THE DRAWINGS

Further objects and features of the teachings of the present disclosure are apparent to a person skilled in the art by putting the present teaching into practice and taking into consideration the accompanying drawings, in which:

FIG. 1 shows a schematic view of an exemplary embodiment of a device incorporating teachings of the present disclosure for closing a vehicle flap of a vehicle;

FIG. 2 shows a schematic view of a further exemplary embodiment of a device incorporating teachings of the present disclosure for closing a vehicle flap of a vehicle; and

FIG. 3 shows an exemplary flowchart of an example method incorporating teachings of the present disclosure for closing a vehicle flap of a vehicle.

### DETAILED DESCRIPTION

The present disclosure provides methods and/or devices for closing a vehicle flap of a vehicle, which, in addition to a first sensor device for contactless detection of a target movement of a body part of a person in the immediate vicinity of the vehicle, also comprises a second sensor device, which is designed to detect movements of the vehicle and, if a movement of the vehicle is detected, to prevent the vehicle door from closing. In particular, the movements of the vehicle may be vibrations or shaking movements caused, for example, by an access-authorized person loading or unloading the car or by a person in the luggage compartment. If, for example when loading or unloading the vehicle, the target movement of the body part of the access-authorized person in the immediate vicinity of the vehicle is made unintentionally, closure due to the detection of the movements of the vehicle can be prevented, thus avoiding accidents due to the closing of the vehicle door.

For example, some embodiments of the teachings herein include a device for closing a vehicle flap of a vehicle. The device may include an opening and closing device which is designed to open or close the vehicle flap, a first sensor device which is designed to contactlessly detect a target movement of a body part of a person safely located in the immediate vicinity of the vehicle, and to provide an activation signal which indicates a desired opening or closing movement of the vehicle flap, a second sensor device, which is designed to detect movements of the vehicle and to generate a movement signal indicating a movement of the vehicle, and a control unit which is designed to receive the activation signal of the first sensor device and the movement signal of the second sensor device and to actuate the opening and closing device. The control unit is further designed to actuate the opening and closing device for the desired closing of the vehicle flap when an activation signal of the first sensor device has been received and the movement signal of the second sensor device indicates a movement of the vehicle which is smaller than a predetermined movement threshold value.

Consequently, in addition to the reception of the activation signal, it is additionally checked whether the vehicle is moving and whether these movements can be attributed to a person within the vehicle or a loading or unloading operation of the vehicle. If such a movement of the vehicle has been detected, closing of the vehicle flap of the vehicle can be prevented or blocked, thus reducing the risk of injury to the person in the immediate vicinity of the vehicle by the closing vehicle door of the vehicle. In particular, by detecting the movement of the vehicle, it can be determined that it is most likely an unintentional target movement of the body part of the person in the immediate vicinity of the vehicle and, consequently, there is no desire to close the vehicle flap, and hence this can also be prevented.

In some embodiments, the first sensor device and the second sensor device are integrated in a common sensor unit. Thus, both sensor devices are integrated in a common housing and mounted on the car in a substantially identical position. In some embodiments, the common housing is mounted in or on a vehicle element.

In some embodiments, the first sensor device and the second sensor device are designed to be mounted on the vehicle separately. This means that the first sensor device and the second sensor device are not mounted on the same vehicle component nor at substantially the same position on the vehicle, and thus represent independent sensor devices.

In some embodiments, the second sensor device is a sensor which is designed to detect shaking or vibration of the vehicle. For example, it can be a vibration sensor, an acceleration sensor, or any sensor that can detect vibrations. It is also possible to detect relative changes in the position of the vehicle with respect to the ground by means of a position sensor. The second sensor device can also be a distance sensor, which can be based, for example, on the ultrasonic principle and can detect any distance changes of the vehicle body relative to the ground. In addition, the second sensor device may be designed as a force sensor, for example in the form of a strain sensor or strain gauge, which is designed to detect (elastic) deformations of the vehicle body, in order thus to be able to infer movements of the vehicle.

In some embodiments, the movement signal indicates shaking movements, vibrations and/or accelerations of the vehicle. In some embodiments, the second sensor device and the movement signal thereby generated is designed to indicate typical shaking movements, vibrations and/or accelerations of the vehicle, which are due to a loading or unloading operation of the vehicle or a person located in the car. For example, these may be the shaking movements, vibrations and/or accelerations of the rear fender of the vehicle.

In some embodiments, the predetermined movement threshold value is defined in such a way that a vehicle which has just begun to move is indicated. A vehicle which has just begun to move is present in particular when the vehicle is subjected to certain shaking movements or vibrations which are typically not present in a vehicle that is stationary, parked or otherwise immobilized. While a vehicle that is stationary, parked or otherwise immobilized may be subject to shaking movements or vibrations due to external influences such as wind and rain, the movement threshold value is, however, predetermined in such a way that it is greater than the shocks or vibrations caused by the external influences.

Furthermore, the predetermined movement threshold value can be provided as a predetermined movement pattern, for example as a predetermined frequency pattern. If the detected movement pattern deviates from the predetermined movement pattern, the movement threshold value can be considered to be exceeded. In addition, the predetermined movement threshold value may also be defined as an amplitude threshold value that indicates a maximum movement of the vehicle.

As another example, some embodiments include a vehicle having a device incorporating teachings of the present disclosure. The sensor device has a detection range in which the target movement of the body part of the person in the immediate vicinity of the vehicle can be contactlessly detected. The first sensor device is mounted on the vehicle in such a way that the detection range of the first sensor device extends at least partially to the outside of the vehicle. Due to the device, this means it is possible to detect unintentional actuations of the first sensor device so that the detection range of the first sensor device can extend further outside the vehicle and a user does not have to move, for example, their leg and foot an unnecessary distance underneath the rear fender.

Some embodiments include a method for closing a vehicle flap of a vehicle. The vehicle has a device comprising an opening and closing device which is designed to open or close the vehicle flap, a first sensor device which is designed to contactlessly detect a target movement of a body part of a person in the immediate vicinity of the vehicle, and a second sensor device, which is designed to detect movements of the vehicle. The method then comprises detecting a target movement of the body part of the person in the immediate vicinity of the vehicle by means of the first sensor device. The target movement indicates a desire to close the vehicle flap. The method further comprises detecting a movement of the vehicle using the second sensor device and actuating the opening and closing device to close the vehicle flap if the detected movement of the vehicle is smaller than a predetermined movement threshold value.

In some embodiments, the detection of the movement of the vehicle comprises detecting shaking of the vehicle and/or detecting vibrations of the vehicle and/or detecting an acceleration of the vehicle.

In some embodiments, the predetermined movement threshold value is defined in such a way that a vehicle which has just begun to move is indicated.

In the context of the present disclosure, “movements of the vehicle” in particular describe shaking movements and/or vibrations of a stationary or parked or otherwise immobilized vehicle. The movements of the vehicle described herein are therefore not intended to include driving movements of the vehicle.

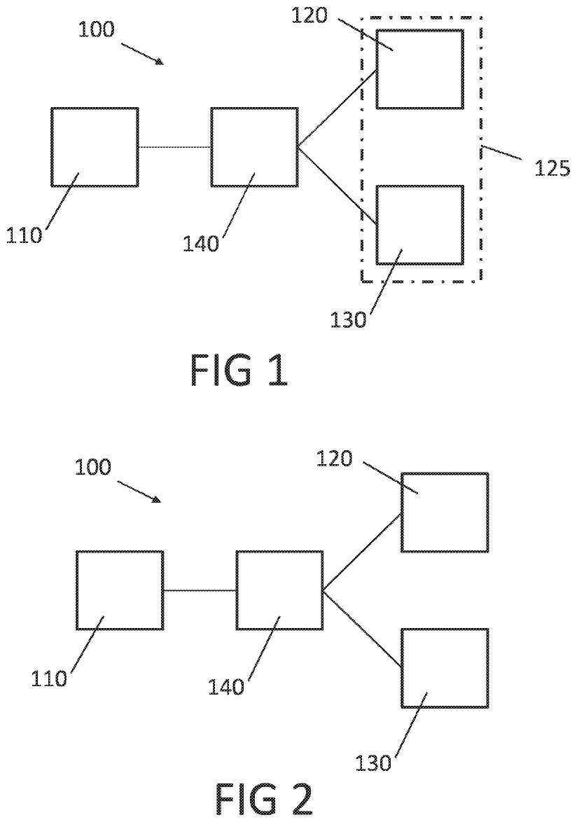

FIG. 1 shows a schematic view of an exemplary embodiment of a device 100 incorporating teachings of the present disclosure for closing a vehicle flap of a vehicle. The vehicle flap may be any vehicle element which can be moved relative to the vehicle and which can be opened or closed to provide access to the interior of the vehicle. For example, the vehicle flap could be a vehicle door, an engine hood, or a liftgate.

To open or close the vehicle flap, the device according to the invention has an opening and closing device 110, which is designed to open or close the vehicle flap. The opening and closing device 110 can move the vehicle flap relative to the vehicle along a predetermined trajectory for opening or closing by means of suitable electronics, hydraulics, and/or pneumatics.

The device 100 further comprises a first sensor device 120, which is designed to contactlessly detect a target movement of a body part of an access-authorized person in the immediate vicinity of the vehicle and to provide an activation signal indicating a desired opening or closing movement of the vehicle flap. The sensor device 120 has a detection range extending substantially into the vehicle surroundings. If the body part, such as a leg and/or a foot, of the access-authorized person is moved with a target movement through the detection range, the desire to open or close the vehicle flap can be detected and an activation signal indicating this desire can be generated. The first sensor device 120 is based on the radar principle, for example. In addition or alternatively, the first sensor device can be a sensor that can detect a characteristic movement or a characteristic movement sequence or a position of the access-authorized person. For example, the first sensor device 120 can be an ultrasonic sensor, a near-field communication sensor (NFC), an optical or a capacitive sensor.

The sensor device 100 further comprises a second sensor device 130, which is designed to detect movements of the vehicle and to generate a movement signal indicating a detected movement of the vehicle. The second sensor device 130 is, for example, an acceleration, shock, and/or vibration sensor, used to detect movements of the vehicle which are generated, for example, in the form of shocks and/or vibrations of the vehicle when loading or unloading the vehicle, or of a person in the luggage compartment, and to generate a corresponding movement signal.

As shown in the example of FIG. 1, the first sensor device 120 and second sensor device 130 are accommodated in a common housing and arranged as a sensor unit 125 on the vehicle, for example in or near the movable vehicle flap. For example, the sensor unit 125 may be arranged behind or integrated in the rear fender of the vehicle.

The device 100 of FIG. 1 further comprises a control unit 140, which is electrically connected to the opening and closing device 110, the first sensor device 120 and the second sensor device 130 and is designed to receive the activation signal of the first sensor device 120 and the movement signal of the second sensor device 130 and to control the opening and closing device 110 for actuating the vehicle flap of the vehicle.

In particular, the control unit 140 is further designed to actuate the opening and closing device 110 for the desired closing of the vehicle flap and thus to bring about a closure of the vehicle flap, when an activation signal of the first sensor device 120 has been received and the movement signal of the second sensor device 130 indicates a movement of the vehicle which is smaller than a predetermined movement threshold value. If the movement of the vehicle is greater than the predetermined movement threshold value, it can be assumed that, for example, a loading or unloading operation of the vehicle is currently taking place and, consequently, this is highly likely to be an unintentional actuation of the first sensor device 120. Consequently, the device 100 according to the invention can be used to prevent closing of the vehicle flap and reduce the risk of injury to the person carrying out the loading or unloading operation.

FIG. 2 shows a further embodiment of the device 100 incorporating teachings of the present disclosure and differs from the device 100 of FIG. 1 in that the first sensor device 120 and the second sensor device 130 are not integrated in a common sensor unit 125, but are separate sensor devices arranged independently of each other on the vehicle.

In particular, in the further embodiment of the device 100 of FIG. 2, the second sensor device 130 may be located remotely from the first sensor device 120 in order, for example, to detect the movements of the vehicle even more accurately to generate a movement signal that indicates the detected movement of the vehicle. For example, the second sensor device 130 can be arranged inside the vehicle, such as in the floor of the luggage compartment, in order to accurately detect activities of the user inside the vehicle, in particular in the luggage compartment of the vehicle. Some examples of such activities are a vehicle loading or unloading operation, a rearrangement of objects being transported within the vehicle, or the use of the transport area as a seating or changing facility.

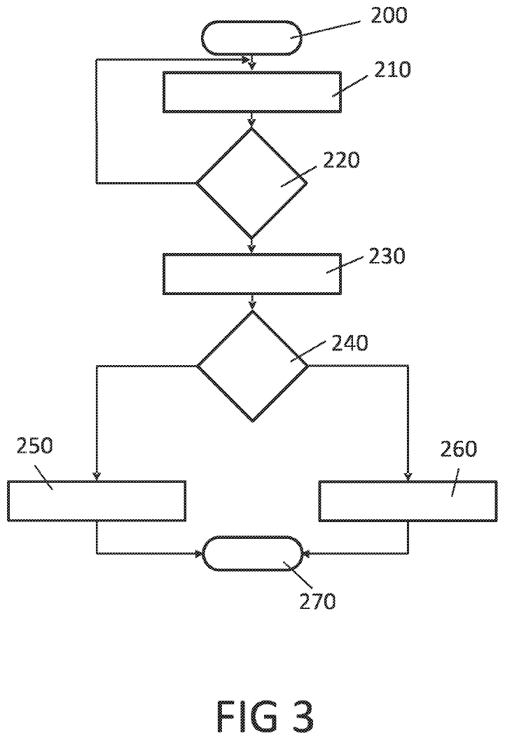

FIG. 3 shows a flowchart of an example method incorporating teachings of the present disclosure for closing a vehicle flap of a vehicle by means of a device 100 of FIG. 1 or 2.

The method of FIG. 3 starts at step 200 and then proceeds to step 210, in which an activation signal is generated by means of the first sensor device 120. In a subsequent step 220, it is checked whether the generated activation signal corresponds to a target movement of the body part of the person located in the immediate vicinity of the vehicle, who is authorized to access the vehicle. Such a target movement indicates, for example, a desire to close the vehicle flap. If it is determined in step 220 that such a target movement of the body part of the person in the immediate vicinity of the vehicle has not been detected, the method returns to step 210.

However, if it is determined at step 220 that a target movement of the body part of the person in the immediate vicinity of the vehicle and authorized to access the vehicle has been detected by means of the first sensor device 120, the method proceeds to step 230, in which the movement signal generated by the second sensor device 130 is also detected.

In a subsequent step 240 it is checked whether the movement of the vehicle detected by means of the second sensor device 130 is smaller than the predetermined movement threshold value. If it is determined in step 240 that the movement of the vehicle is smaller than the predetermined movement threshold value, the method proceeds to step 250, in which the control device 140 actuates the opening and closing device 110 to close the vehicle flap before the method is terminated at step 270.

However, if it is determined in step 240 that the movements of the vehicle detected by means of the second sensor device 130 are greater than the predetermined movement threshold value, the method proceeds to step 260, in which closing of the vehicle flap is prevented. This prevention can be effected by the control device 140 being designed not to actuate the opening and closing device 110. The method then ends again at step 270.

In particular, any detected movement of the vehicle which is greater than the predetermined movement threshold value indicates that it most likely involves an unintentional actuation of the first sensor device 120 and a closing of the vehicle flap is thus not desired. In particular, this may be the case if the first sensor device 120 is accidentally actuated during loading or unloading of the vehicle by the target movement of the body part being performed inadvertently.

By means of a device and/or a method incorporating teachings of the present disclosure, unintentional activation of the first sensor device can be detected and closing of the vehicle flap can be prevented, so that the risk of injury caused by an unintentionally closing vehicle flap can be reduced.

What is claimed is:

1. A device for closing a vehicle flap of a vehicle, the device comprising:
an opening and closing device to open and close the vehicle flap;
a first sensor to contactlessly detect a target movement of a body part of a person in an immediate vicinity of the vehicle and to provide an activation signal indicating a desired opening or closing movement of the vehicle flap;
a second sensor to detect movements of the vehicle and to generate a movement signal indicating a detected movement of the vehicle; and
a control unit to receive the activation signal and the movement signal and, in response, to actuate the opening and closing device;
wherein the control unit actuates the opening and closing device for the desired closing of the vehicle flap when an activation signal of the first sensor has been received and the movement signal of the second sensor indicates a movement of the vehicle smaller than a predetermined movement threshold value.

2. The device as claimed in claim 1, wherein the first sensor and the second sensor are integrated in a sensor unit.

3. The device as claimed in claim 1, wherein the first sensor devise and the second sensor are mounted separately from each other on the vehicle.

4. The device as claimed in claim 1, wherein the second sensor comprises: a vibration sensor, an acceleration sensor, a position sensor for detecting relative position changes of the vehicle with respect to the ground, a distance sensor for detecting distance changes of the vehicle body with respect to the ground, and/or a force sensor for detecting deformations of the vehicle body.

5. The device as claimed in claim 1, wherein the movement signal indicates: shocks, vibrations and/or accelerations of the vehicle.

6. The device as claimed in claim 1, wherein the predetermined movement threshold value indicates the vehicle has just begun to move.

7. A vehicle comprising:
a passenger cabin;
a vehicle flap;
an opening and closing device to open and close the vehicle flap;
a first sensor to contactlessly detect a target movement of a body part of a person in an immediate vicinity of the vehicle and to provide an activation signal indicating a desired opening or closing movement of the vehicle flap;
a second sensor to detect movements of the vehicle and to generate a movement signal indicating a detected movement of the vehicle; and
a control unit to receive the activation signal of the first sensor device and the movement signal of the second sensor device, and to actuate the opening and closing device;
wherein the control unit actuates the opening and closing device for the desired closing of the vehicle flap when an activation signal of the first sensor has been received and the movement signal of the second sensor indicates a movement of the vehicle smaller than a predetermined movement threshold value
wherein the first sensor has a detection range in which the first sensor can contactlessly detect a target movement of the body part of the person in the immediate vicinity of the vehicle, and is mounted on the vehicle so the detection range of the first sensor extends at least partially to the outside of the vehicle.

8. A method for closing a vehicle flap of a vehicle including an opening and closing device to open and close the vehicle flap, a first sensor to contactlessly detect a target movement of a body part of a person in an immediate vicinity of the vehicle, and a second sensor to detect movements of the vehicle, the method comprising:
detecting a target movement of the body part of the person in the immediate vicinity of the vehicle by the first sensor, the target movement indicating a desired closing of the vehicle flap;
detecting a movement of the vehicle by the second sensor; and
actuating the opening and closing device for closing the vehicle flap if the detected movement of the vehicle is smaller than a predetermined movement threshold value.

9. The method as claimed in claim 6, wherein the detection of the movement of the vehicle comprises:
detecting shaking of the vehicle,
detecting vibrations of the vehicle, and/or
detecting an acceleration of the vehicle.

10. The method as claimed in claim 8, wherein the predetermined movement threshold value indicates the vehicle has just begun to move.
